(19) United States
(12) Patent Application Publication
(10) Pub. No.: US 2005/0037645 A1
(43) Pub. Date: Feb. 17, 2005

(54) Electrical card connector

(76) Inventor: Hung-Chi Yu, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/917,934

(22) Filed: Aug. 13, 2004

(30) Foreign Application Priority Data
Aug. 13, 2003 (TW) 92214636

(51) Int. Cl. H01R 13/648

(52) U.S. Cl. 439/108

(57) ABSTRACT

An electrical card connector (1) comprises an insulative housing (2), a plurality of contacts (23) received in the insulative housing, a shell (3), an ejector (4), a grounding member (5) and a retention device (6). The insulative housing defines a plurality of passageways extending therethrough. The contacts include signal contacts (231) received in the passageways, and a pair of grounding contacts (232) positioned at a rear end of the insulative housing. The shell is assembled to the insulative housing and together defines a receiving space for receiving an electrical card. The grounding member is located at a rear end of the electrical card connector and includes a body portion (51), a plurality of grounding plates (52) extending into the receiving space from the body portion, and a pair of grounding fingers (54) electrically contacting the grounding contacts.

### BACKGROUND OF THE INVENTION

1. Field of the Invention

The present invention generally relates to an electrical card connector, and particularly to an electrical card connector having an improved grounding member for preventing electromagnetic interference (EMI).

2. Description of Prior Arts

With the development of portable computer, the dimension of the portable computer gets more and more smaller. At the same time, the computer needs more memory cards to meet the requirement of signal transmission. The electrical card connectors are widely used in the portable computer. However, in order to meet the miniature trend for portable computer, high transmitting speed and highly concentrated arrangement of contacts will result and will cause EMI to influence qualities of signals. U.S. Pat. No. 6,354,876 discloses such an electrical card connector 1 (referring to FIG. 1) having a grounding plate 40. The grounding plate comprises a plurality of tongues 46 extending inwardly and contacting a surface of an electrical card, and a plurality of soldering fingers 44 soldered to grounding path on a printed circuit board (PCB) for eliminating EMI in the surface of the electrical card. However, the grounding plate is made from a metal sheet. When the soldering fingers are soldered on the PCB, the grounding plate will absorb heat and bring about stress concentration. After cooling the grounding plate, the stress will be released to cause deformations and affect grounding quality.

Hence, it is desirable to have an improved connector to overcome the above-mentioned disadvantages of the prior art.

### BRIEF SUMMARY OF THE INVENTION

Accordingly, it is an object of the present invention to provide an electrical card connector which has a grounding member to mate with a shell for achieving a good electrical performance.

In order to achieve the above-mentioned objects, an electrical card connector includes an insulative housing, a plurality of contacts received in the insulative housing, a shell, an ejector, an grounding member, and a retention device.

The insulative housing defines a plurality of passageways extending therethrough. The contacts include signal contacts received in the passageways, and a pair of grounding contacts being positioned at a rear end of the insulative housing. The shell is assembled to the insulative housing and together defines a receiving space for receiving an electrical card. The grounding member is located at a rear end of the electrical card connector and includes a body portion, a plurality of grounding plates extending into the receiving space from the body portion, and a pair of grounding fingers electrically contacting the grounding contacts.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of a prior art electrical card connector;

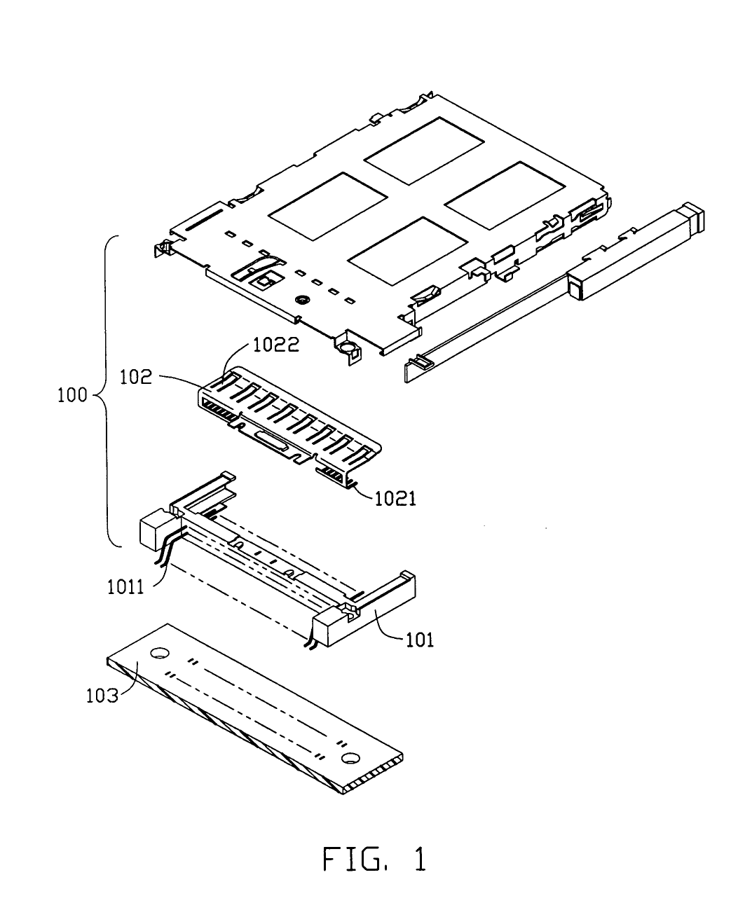

FIG. 2 is an exploded, perspective view of an electrical card connector in accordance with the present invention;

FIG. 3 is an assembled, perspective view of the electrical card connector shown in FIG. 2;

FIG. 4 is an exploded, perspective view of an electrical card connector of a second embodiment in accordance with the present invention;

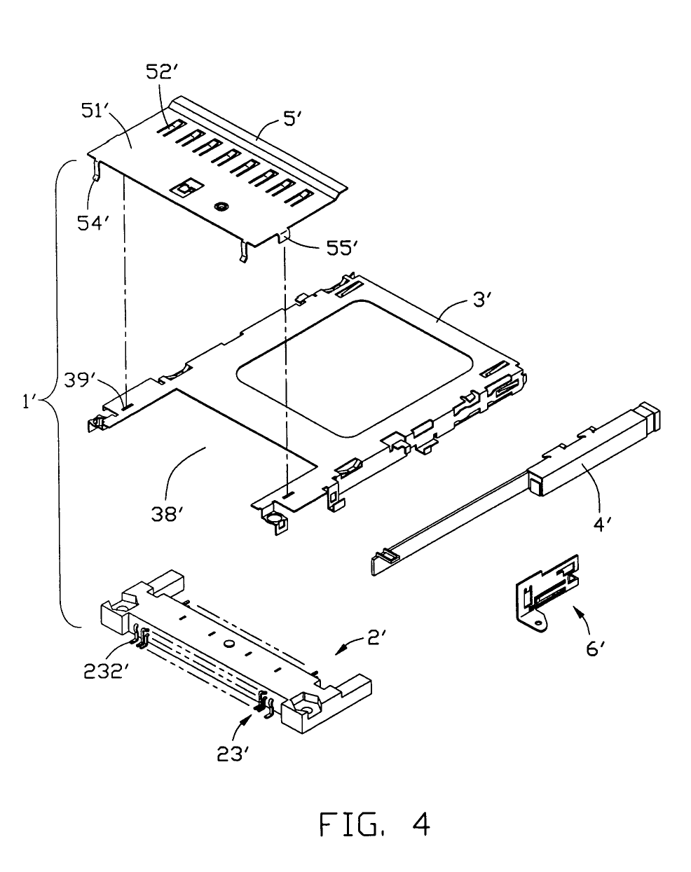

FIG. 5 is an assembled, perspective view of the electrical card connector shown in FIG. 4;

FIG. 6 is a partly cross-sectional view taken along line 6-6 of FIG. 5;

FIG. 7 is exploded, perspective view of an electrical card connector of an other embodiment in accordance with the present invention;

FIG. 8 is an enlarged view of a grounding contact of the electrical card connector of FIG. 3; and

FIG. 9 is a cross-sectional view taken along line 9-9 of FIG. 3.

### DETAILED DESCRIPTION OF THE PREFERRED EMBODIMENT

Reference will now be made to the drawing figures to describe the present invention in detail.

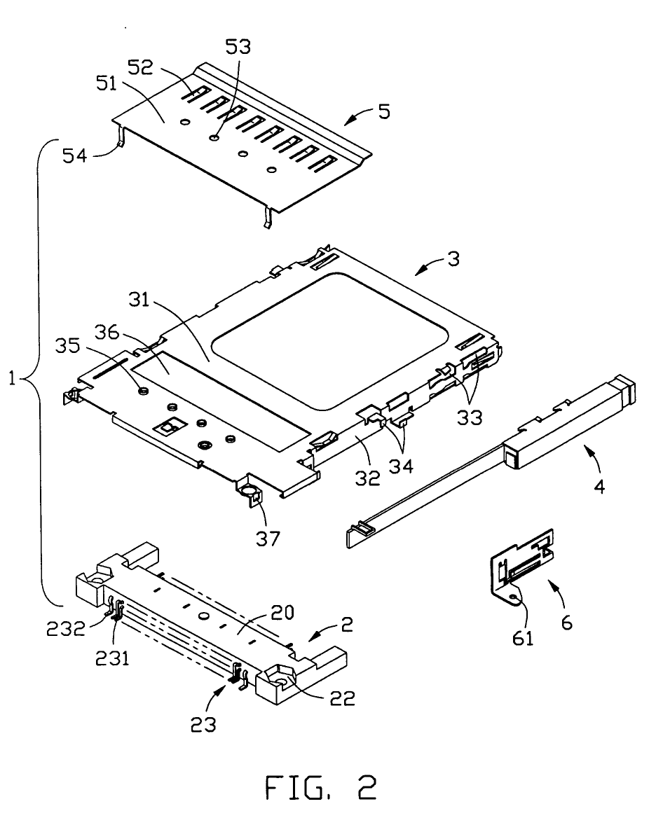

With reference to FIG. 2, an electrical card connector 1 is mounted on a printed circuit board (not shown) and comprises an insulative housing 2, a plurality of contacts 23 received in the insulative housing 2, a shell 3, an ejector 4, a grounding member 5, and a retention device 6.

The insulative housing 2 comprises a rectangular base 20 defining a plurality of passageways (not shown). The contacts 23 are received in the passageways. The contacts comprise a plurality of signal contacts 231 and a pair of grounding contacts 232. The grounding contacts 232 are respectively positioned at two outer sides of the signal contacts 231. The base 20 defines a pair of recesses 22 at opposite sides thereof.

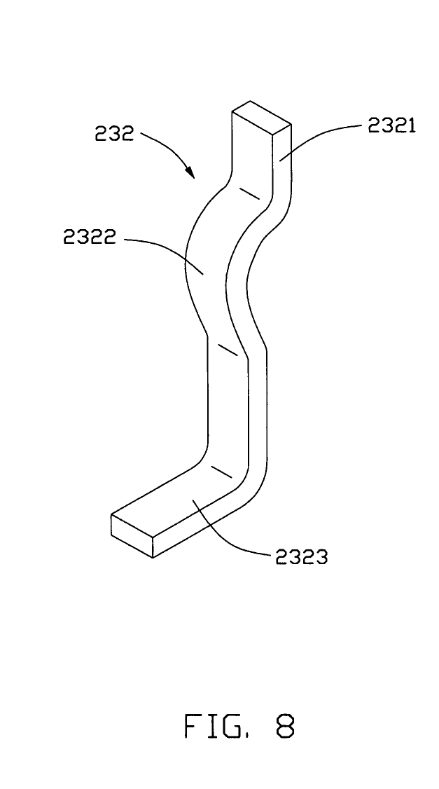

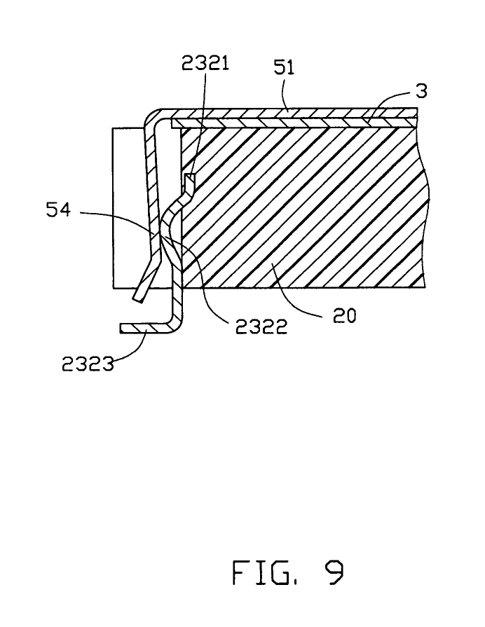

Referring to FIGS. 8 and 9, each grounding contact 232 comprises a curved portion 2322, an engaging portion 2321 extending forwardly from the curved portion 2322 and insert-molded with the insulative housing 2, and a mounting portion 2323 extending downwardly and bent rearwardly from the curved portion 2322.

Referring to FIG. 2, the shell 3 is made from a metal sheet and comprises a top wall 31, and opposite side walls 32 extending downwardly from the top wall 31. The top and side walls 31, 32 together define a receiving space for receiving an electrical card (not shown). A connecting area between the top and side walls 31, 32 defines a plurality of cavities 33 and locking members 34 for securing the ejector 4 and the retention device 5. The cavities 33 and the locking member 34 of electrical card connectors are known in the art so that they will not be described here. A row of protrusions 35 are positioned at a rear end of the top wall 31 and arranged parallel to each other. A rectangular opening 36 is formed at a front end of the top wall 31. A pair of retention portions 37 extend downwardly from rear ends of the side walls 32.

The grounding member 5 is also made from a metal sheet and comprises a body portion 51, a plurality of grounding plates 52 extending inwardly from the body portion 51 and arranged parallel to each other, a plurality of holes' 53 corresponding to the protrusions 35, and a pair of grounding fingers 54 bent downwardly from a rear side of the body portion 51

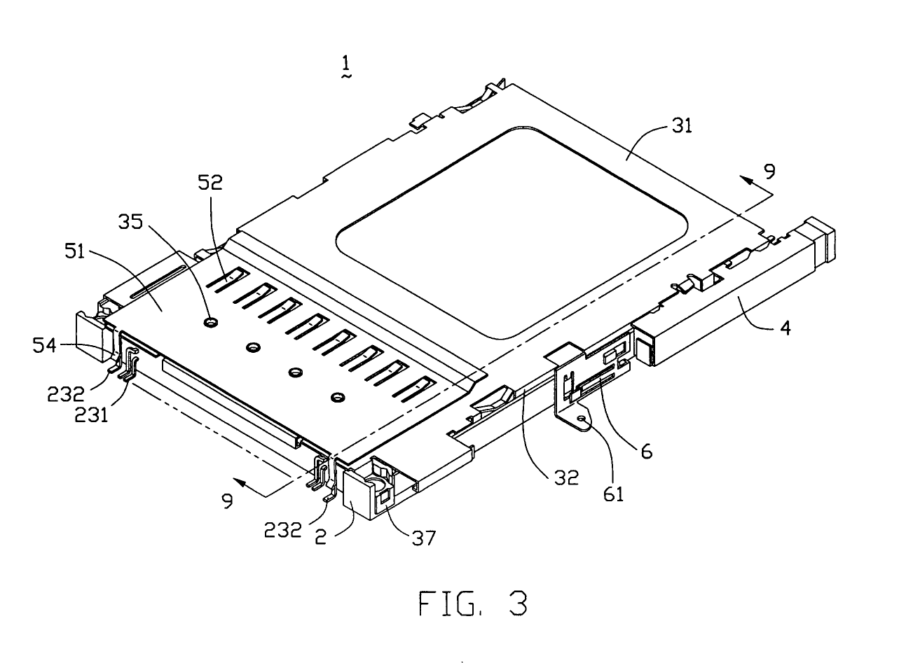

Referring to FIG. 3, in assembly, the shell 3 is assembled to the insulative housing 2, the retention portions 37 are mated with the recesses 22 of the insulative housing 2, and then a pair of screws (not shown) are inserted into the retention portions 37 and the recesses 22 for securing a connection between the insulative housing 2 and the shell 3. The protrusions 35 of the shell 3 mate with the holes 53 of the grounding member 5 for connecting the shell 3 and the grounding member 5. The grounding plates 52 are positioned a position corresponding to the opening 36 and extend through the top wall 31 of the shell 3. When the electrical card is inserted into the receiving space of the electrical card connector 1, the grounding plates 52 contact corresponding convex points on a surface of the electrical card for achieve an electrical connection. The grounding fingers 54 of the grounding member 5 engage with the curved portion 2322 of the grounding contacts 232 for achieving an electrical connection between the grounding member 5 and the grounding contacts 232.

The ejector 4 is secured in the side wall 32 through the cavities 33 and locking members 34. The retention device 6 is secured in the side wall 32 by the locking member 34, and a pair of bolts (not shown) are inserted into corresponding holes 61 for securing the retention device 6 on the PCB. The ejector 4 and the retention device 6 are also prior art themselves, and thus will not be further described here.

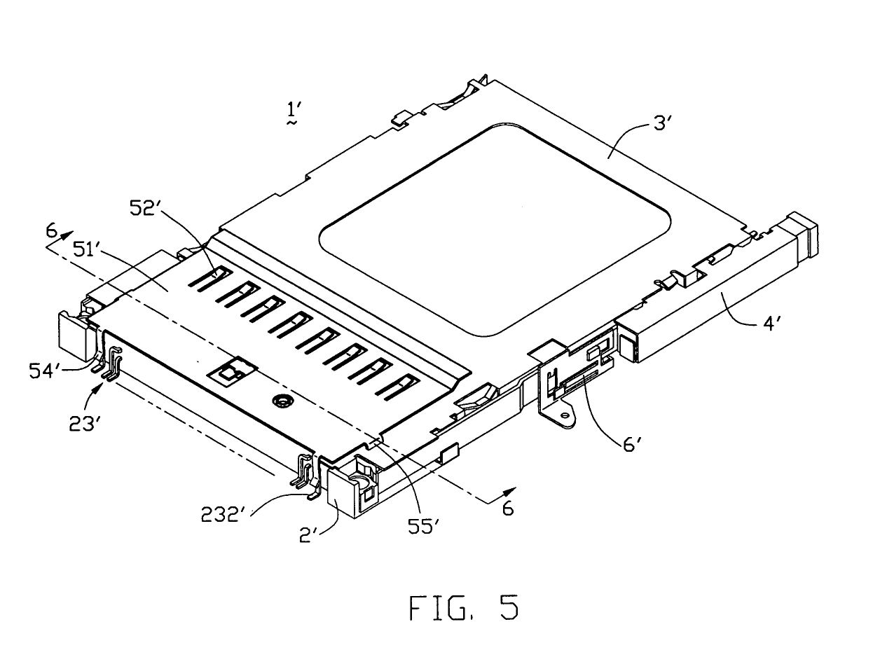

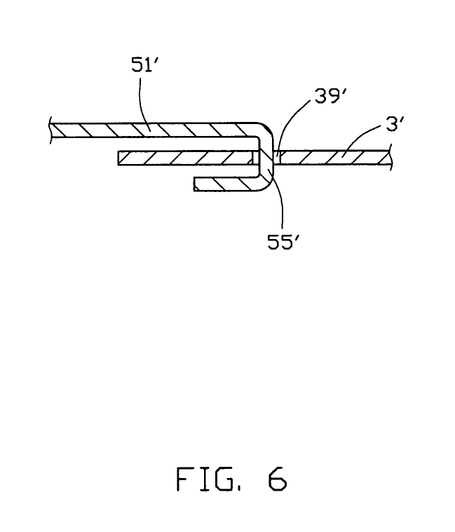

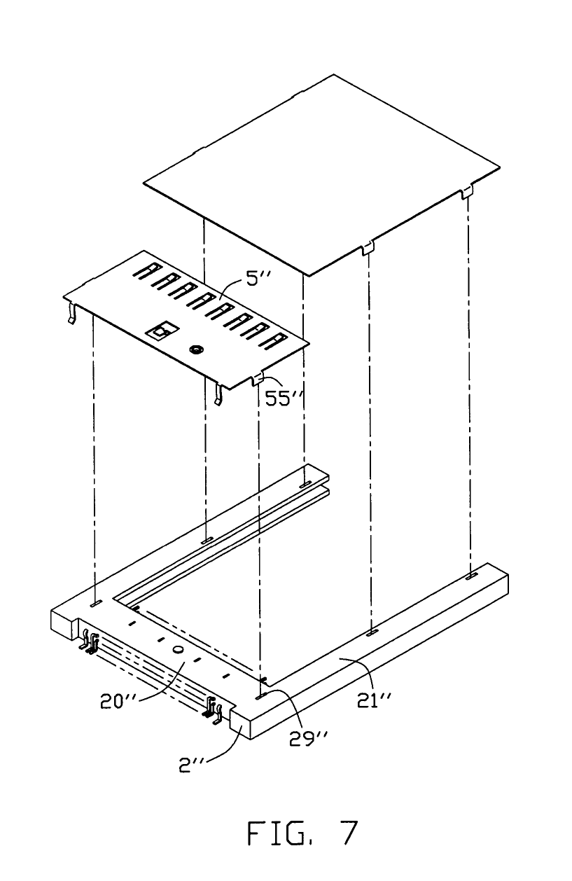

In second embodiment, referring to FIG. 5, the electrical card connector 1′ comprises an insulative housing 2′, a plurality of contacts 23′ a shell 3′ an ejector 4′, grounding member 5′, and the retention device 6′. Accomplished manner of the insulative housing 2′, the contacts 23′, the ejector 4′, and the retention device 6′ is similar to the first embodiment. The difference between the first and the second embodiment is in grounding manner. The feature of the second embodiment is in the shell 3′ and the grounding member 5′. The shell 3′ comprises a top wall 31′, a rectangular opening 38′ at a rear end of the top wall 31′. A pair of slits 39′ is defined at two sides of the opening 38′. The grounding member 5′ further comprises a pair of grasping arms 55′ at two side end of a body portion 51′. Referring to FIGS. 6 and 7. In assembly, the grasping arms 55′ are inserted into the slits 39′ of the shell 3′ and folded inwardly for securing the shell 3′ and the grounding member 5′.

In other embodiment, referring to the FIG. 7. An insulative housing 20″ has two side arms 21″ defining a plurality of slits 29″ thereof. A grounding member 5″ is divided into two parts and forms a plurality of grasping arms 55″ at two side thereof. The grasping arms 55″ mates with corresponding slits 29″ for making a connection between the grasping member 55″ and the insulative housing 20″.

In electrical card connector 1, 1′ of the present invention, the grounding member 5, 5′ contact the grounding contacts 232, 232′ for making an electrical connection and achieving grounding purpose. When the electrical card connector 1, 1′ is mounted on the PCB, the tail portions of the contacts 23, 23′ are mounted on the PCB by Surface Mount Technology (SMT). In such a way, the process of assembly is convenient and effectively reduces occupied space on the PCB so as to meet the miniature requirements for portable computers.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical card connector comprising:
an insulative housing defining a plurality of passageways extending therethrough;
a plurality of signal contacts received in the passageways;
a pair of grounding contacts being positioned at a rear end of the insulative housing;
a shell assembled to the insulative housing and, together with the insulative housing defining a receiving space for receiving an electrical card; and
a grounding member located near a rear end of the shell and including a body portion, a plurality of grounding plates extending into the receiving space from the body portion, and a pair of grounding fingers electrically contacting the grounding contacts, respectively.

2. The electrical card connector as described in claim 1, wherein the grounding member is secured at the rear end of the shell.

3. The electrical card connector as described in claim 2, wherein the body portion of the grounding member defines a plurality of holes thereof.

4. The electrical card connector as described in claim 3, wherein the shell forms a plurality of corresponding protrusions for mating with the holes of the grounding member.

5. The electrical card connector as described in claim 4, wherein an opening is defined at the rear end of the shell.

6. The electrical card connector as described in claim 5, wherein the grounding plates of the grounding member extend through the opening into the receiving space.

7. The electrical card connector as described in claim 1, wherein the shell defines a rectangular opening at the rear end and a pair of slits at two sides of the opening.

8. The electrical card connector as described in claim 1, wherein the body portion of the grounding member forms a pair of grasping arms bent downwardly from two sides thereof for mating with the slits of the shell.

9. The electrical card connector as described in claim 8, wherein the grounding plates of the grounding member extend through the rectangular opening to the receiving space.

10. The electrical card connector as described in claim 1, wherein the insulative housing has two side arms each defining a plurality of slits thereof.

11. The electrical card connector as described in claim 1, wherein the grounding member forms a plurality of grasping arms for mating with the slits of the side arms.

12. An electrical connector assembly comprising:
a printed circuit board;
an insulative housing mounted on the printed circuit board and defining a plurality of passageways extending therethrough;
a plurality of signal contacts received in the passageways;
at least one grounding contact being positioned at a rear end of the insulative housing and soldered unto the printed circuit board; and
a grounding member vertically located on the housing near the rear end of the housing and at least one grounding finger extending from said grounding member to mechanically and electrically contact the grounding contact.
